(19) United States
(12) Patent Application Publication
(10) Pub. No.: US 2010/0049335 A1
(43) Pub. Date: Feb. 25, 2010

(54) DATA STRUCTURE & ASSOCIATED METHOD FOR AUTOMATION CONTROL SYSTEM MANAGEMENT

(75) Inventors: Lars-Eric Assarsson, Klagshamn (SE); Per-Ola Olsson, Malmo (SE); Micael Carlstedt, Malmo (SE); Marcus Skälstad, Malmo (SE); Johan Larsson, Trelleborg (SE)

Correspondence Address: BUCHANAN, INGERSOLL & ROONEY PC, POST OFFICE BOX 1404, ALEXANDRIA, VA, 22313-1404, US

(73) Assignee: TAC AB, Malmo (SE)

(21) Appl. No.: 12/443,291

(22) PCT Filed: Sep. 21, 2007
(86) PCT No.: PCT/EP2007/008228

§ 371 Date: Apr. 29, 2009

Related U.S. Application Data
(60) Provisional application No. 60/849,844, filed on Oct. 6, 2006.

(30) Foreign Application Priority Data
Oct. 6, 2006 (SE) 0602143-0

(51) Int. Cl. G05B 15/02; G05B 19/042

(52) U.S. Cl. 700/9; 700/17

(57) ABSTRACT

A data structure comprising a link to a set of binding points enabling connection to a building control system and a model of said automation control system is disclosed. The model comprises a plurality of virtual components arranged in a structure associated with functions of said automation control system. Each virtual component is assigned a set of properties for viewing a representation of said virtual component. Each set of properties comprises a first sub-set of properties being linked to said binding points such that actual values for corresponding actual component are provided to said virtual component, and a second sub-set of properties for how said representation of said virtual component is to be viewed with respect to said actual values. Each property of said second sub-set of properties selectably comprises a locally or a globally assigned parameter. An automation system management tool utilising the data structure, and an automation control system comprising the tool are disclosed. Further, a method and a computer program implementing the method, utilising the data structure are disclosed.

### TECHNICAL FIELD

The present invention relates to an automation control management tool and an automation control system utilising such an automation control management tool. The present invention further relates to a method for automation control management, a computer program for implementing such a method, and a data structure to be utilised by such a computer program.

### BACKGROUND OF THE INVENTION

Automation control systems have been present in industry applications for some time, but have become present more and more in any context of our everyday life. Examples are systems for building control, safety arrangements, automotive applications, etc. In addition to this, these systems become more complex, and/or give a user or operator more options to configure the systems and the way they operate. So far, there has only been disclosed approaches for user interfaces simply indicating status for one or a few parts of such a system in question. Other approaches has been present for configuring parts of the system, which normally has been done by programming one or more PLCs (Programmable Logic Controllers) of the system. However, these approaches have made it difficult to manage the system, implying a demand for numerous specialists in different fields (programming, system architecture, etc.), and a demand for extensive training of users and operators. Therefore, there is a demand for facilitating for a user or an operator to manage the system.

### SUMMARY OF THE INVENTION

In view of the above, an objective of the invention is to solve or at least reduce the problems discussed above. In particular, an objective is to provide an approach to facilitate managing an automation control system.

The present invention is based on the understanding that an operator or user more intuitively understands functions and issues of a system when an overview and particulars of the system are presented graphically, and that this presentation has been able to be achieved by modern computer technology. In particular, the present invention is based on the understanding that interaction between a structure for modelling an automation system and a management tool for the automation system will highly facilitate management of the system, i.e. design, putting into operation, maintenance, re-configuration, etc. of the system

According to a first aspect of the present invention, there is provided an automation control management tool comprising

a processor,

a graphical user interface, and

a set of binding points to enable connection to an automation control system, wherein

said processor holds a model of said automation control system,

said model comprising a plurality of virtual components arranged in a hierarchical structure associated with functions of corresponding actual components of said automation control system, wherein

each virtual component is assigned a set of properties for viewing a representation of said virtual component by said graphical user interface, wherein

said each set of properties comprises

a first sub-set of properties being linked to said binding points such that actual values for corresponding actual components are provided to said virtual components, and

a second sub-set of properties being assigned parameters for how said representation of said virtual component is to be viewed with respect to said actual values, wherein

each property of said second sub-set of properties selectably comprises a locally or a globally assigned parameter.

A particular advantage of this is provision of a tool for handling, managing, setting up, supervising, etc. an automation control system, where the tool itself is easily manageable.

The model may comprise an appearance and/or behaviour of components' functions of an actual system, as well as an overall appearance and behaviour of the actual system. The binding points are normally connected to signals or data representations of a physical system, which may be e.g. a building control system in operation. However, the present invention is also applicable to design phase of an automation control system, where binding points are connected to a simulation of the system under design. The simulation may be performed by one or more computers simulating the behaviour of the system. Thus, design of the system and the management tool for the system can be designed and configured in parallel, which enables shorter lead time.

The locally assigned properties may depend on a value of at least one binding point. Similarly, the globally assigned properties may depend on a value of at least one binding point. The globally assigned properties may depend on a set of values of a set of binding points. These features provides for a flexible tool that can be adapted to reflect properties of interest from the actual automation control system in a way that facilitates for an operator of the automation control system. It should be noted that all of these features may be present at the same time for making a good picture of different parts of the system.

The tool may comprise an editing mode, wherein said graphical user interface provides a field for editing said parameters. A locally assigned parameter may be editable by accessing said representation of said virtual component in said editing mode. A globally assigned parameter may be editable by exposing said global parameter and performing at least one of the actions amending the parameter and/or re-naming the parameter. These properties provides for a flexible tool which can be adaptable to a desired presentation of properties of interest of the automation control system, or to any changes in the configuration of the automation control system.

The set of properties may comprise a selectable assigned minimum value and a selectable assigned maximum value. This provides for a selectable range of values that are of interest for monitoring for any component in the system.

A representation of a virtual component in said graphical user interface may be arranged to receive a user settable value, wherein said value is linked to its associated binding point for controlling said corresponding actual component. This provides for being able to use the tool for controlling parameters of the automation control system, and especially to do this in a way that is easily survey for an operator.

The tool may comprise a component editor, wherein a component of said virtual components is editable. The component editor may enable grouping of a plurality of components as sub-components of a complex component, wherein said complex component is handled as any virtual component.

The tool may comprise a model editor, wherein said model is editable.

The tool may comprise a snippet library comprising snippets defining properties to enable assigning said properties to a virtual component. The tool may further comprise a snippet editor, wherein an edited snippet is added to said snippet library.

These features provides for further flexibility of the tool.

According to a second aspect of the present invention, there is provided an automation control system comprising a physical automation control system and a management tool comprising

a processor,

a graphical user interface, and

a set of binding points to enable connection to said physical automation control system, wherein

said processor holds a model of said physical automation control system,

said model comprising a plurality of virtual components arranged in a structure associated with functions corresponding actual components of said physical automation control system, wherein

each virtual component is assigned a set of properties for viewing a representation of said virtual component by said graphical user interface, wherein

said each set of properties comprises

a first subset of properties being linked to said binding points such that actual values for corresponding actual components are provided to said virtual components, and

a second subset of properties for how said representation of said virtual component is to be viewed in said graphical user interface with respect to said actual values, wherein

each property of said second subset of properties selectably comprises a locally or a globally assigned parameter.

The globally and locally assigned properties and values of the binding point may show similar features as those demonstrated for the first aspect of the present invention.

A representation of a virtual component in said graphical user interface may be arranged to receive a user settable value, wherein said value is linked to its associated binding point for controlling said corresponding actual component. This provides for a very neat way of managing the system.

According to a third aspect of the present invention, there is provided a method comprising

associating virtual components of a model of an automation control system with actual components of the automation control system;

assigning a set of properties to said virtual components;

viewing a representation of said virtual components according to said set of properties, wherein

said each set of properties comprises

a first subset of properties being linked to said binding points such that actual values for corresponding actual components are provided to said virtual components, and

a second subset of properties comprising parameters for how said representation of said virtual component is to be viewed with respect to said actual values, wherein said method further comprises

assigning said parameters selectably locally or globally of each property of said second subset of properties.

The method may further comprise editing said parameters.

The method may further comprise selecting a virtual component for editing; accessing said representation of said selected virtual component; and assigning said parameter locally.

The method may further comprise exposing a globally assigned parameter; and amending said exposed parameter.

The method may further comprise assigning for a selected property a minimum value; and assigning a maximum value for said selected property.

These features provides for a flexible method for handling, managing, setting up, supervising, etc. an automation control system.

The method may further comprise receiving a user selectable value associated with a representation of a virtual component; and assigning said user selectable value to a binding point for controlling a corresponding actual component.

The method may further comprise editing a virtual component, wherein said editing comprises grouping a plurality of components as sub-components of a complex component, and assigning said complex component as a virtual component.

The method may further comprising editing said model.

The method may further comprise accessing a snippet from a snippet library, wherein said snippet defines properties of a virtual component; editing said snippet; and storing said edited snippet in said snippet library.

According to a fourth aspect of the present invention, there is provided a computer program comprising program code adapted to perform actions of the method according to the third aspect of the present invention when the program is run on a computer.

According to a fifth aspect of the present invention, there is provided a data structure comprising

a link to a set of binding points enabling connection to an automation control system; and

a model of said automation control system, wherein said model comprises

a plurality of virtual components arranged in a structure associated with functions of said automation control system, wherein each virtual component is assigned a set of properties for viewing a representation of said virtual component, wherein each set of properties comprises a first sub-set of properties being linked to said binding points such that actual values for corresponding actual component are provided to said virtual component, and a second sub-set of properties for how said representation of said virtual component is to be viewed with respect to said actual values, wherein each property of said second sub-set of properties selectably comprises a locally or a globally assigned parameter.

In the data structure, globally assigned properties and values of binding points have similar relations as those demonstrated for the first aspect of the present invention.

In the data structure, a globally assigned parameter may be editable by exposing said global parameter and performing the actions amending the parameter and/or re-naming the parameter.

In the data structure, said set of properties may comprise a selectable assigned minimum value and a selectable assigned maximum value.

In the data structure, a virtual component of said virtual components may be a group of a plurality of components as sub-components of a complex component, wherein said complex component is handled as any virtual component.

The data structure may further comprise a snippet library comprising snippets defining properties to enable assigning said properties to a virtual component.

The above discussed features of the data structure provides for similar advantages and effects as demonstrated for the first to fourth aspects of the present invention.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The actions of any method disclosed herein do not have to be performed in the exact order disclosed, unless explicitly stated.

Other objectives, features and advantages of the present invention will appear from the following detailed disclosure, and from the attached dependent claims, as well as from the drawings.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

### DETAILED DESCRIPTION OF PREFERRED EMBODIMENTS

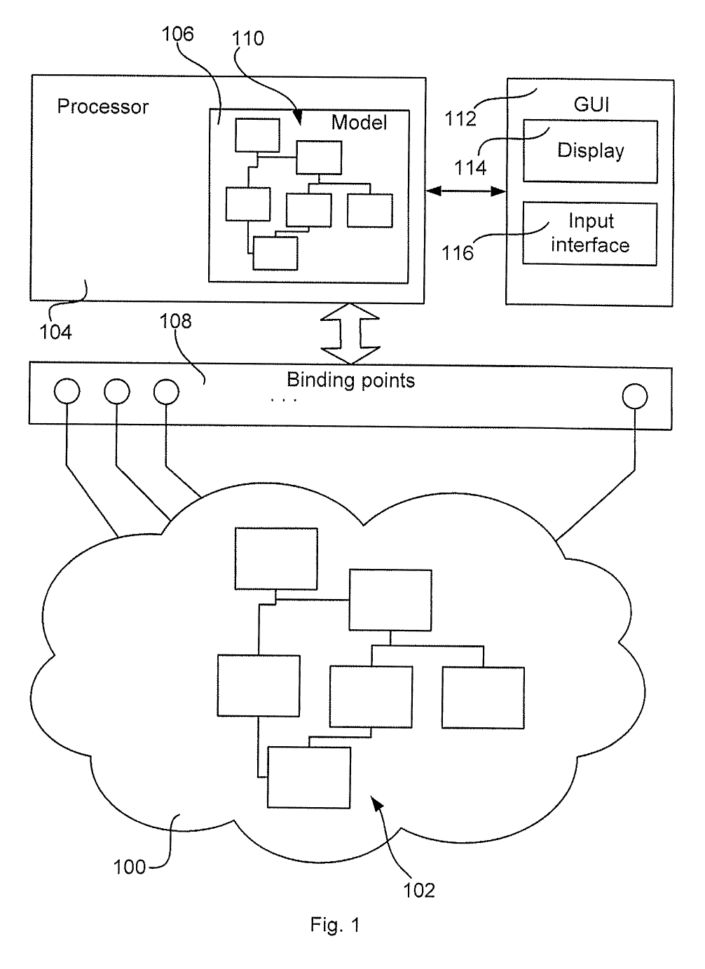

FIG. 1 schematically illustrates an embodiment of the present invention. An automation control system 100, which can be a system for HVAC, lighting, security, etc. in a building, a system for control of industrial production, a control system of a vessel, etc., comprises a plurality of components 102 for implementing the functions of the automation control system 100. A system like this often becomes very complex, and there is a need for those operating the system to get a clear view of the system. Therefore, the present invention provides a tool for providing improved operation of the system. A processor 104 holds a model 106 of the system 100. The model is preferably implemented in software to provide great flexibility, e.g. as there are changes in the configuration of the system 100, the model 106 is easily changed accordingly, as will be further described below. However, the model can also be hard-wired or partly hard-wired, e.g. where the system is a standardized embedded system, which may be the case for vehicles or vessels. For example, the model can in those cases be implemented as a Field Programmable Gate Array or an Application-Specific Integrated Circuit. However, for the most applications, the model 106 is implemented as software in a generic computer. The model 106 can comprise an appearance and/or behaviour of components' functions of the system 100, as well as an overall appearance and behaviour of the system 100.

The model 106 has a structure that has at least one link to a set of binding points 108 which are connected to the automation control system 100. The binding points 108 are normally connected to a physical system 100, which may be e.g. a building control system in operation. However, the present invention is also applicable to design phase of an automation control system 100, where binding points are connected to a simulation of the system under design. Thus, the system 100 can be a simulator simulating the system under design. The simulation can be performed by one or more computers simulating the behaviour of the system. Thus, design of the system and the management tool for the system can be designed and configured in parallel, which enables shorter lead time. The simulator can be integrated with the processor 104, wherein the processor 104 can be considered to have two modes of operation: engineering mode for design and simulation, and operation mode for operating an actual system in operation. The structure further comprises a plurality of virtual components 110 arranged to reflect the functions of the automation control system 100, preferably in a similar structure as the components 102 of the automation control system 100. Each virtual component 110 is assigned a set of properties for viewing a representation of the virtual component in a graphical user interface (GUI) 112. Each set of properties comprises a first sub-set of properties being linked to said binding points 108 such that actual values for corresponding actual component 102 are provided to said virtual component 110. A second sub-set of properties for how the representation of the virtual component is to be viewed is also comprised in each set of properties. The second sub-set of properties preferably designates how the representation should appear when displayed with respect to the actual values. Here, dynamics of a component 102 can be illustrated by the representation of the corresponding virtual component 110. This can be performed by assigning the property, e.g. a function depending on one or more of values of the binding points 108 and/or interactions with other components, and the function defining a visual appearance of the representation of the component 110, such as color, orientation, animations, presentation of values, etc. These properties of the second sub-set of properties can selectably be assigned locally, i.e. an assignment is done for each virtual component, or be assigned globally as a variable, i.e. all virtual components being assigned this variable will follow the globally assigned value or function. Further, a value of one binding point can be associated with a number of functions and/or components.

An example is that a value of a binding point is associated to a first virtual component and is assigned to represent the first component in a certain way depending on the value. This can be an animation of an analog or digital gauge representing the value. The value can also be associated to a second virtual component, e.g. illustrating positions of elements of damper. In this example, the value of the gauge and the position of the elements of the damper can be directly dependent on the value. There can also be a third virtual component, e.g. a second damper, which behaviour is a function dependent on the value, say being the inverse of the function of the first damper, which also depends on the value. A fourth virtual component can be dependent on both this value and a second value of another binding point, say a fan which is illustrated to animate actual rotation of a corresponding fan, which rotation the second value represents. The fourth virtual component's dependency on the first value can be that, determined from the first value and the second value, based on the positions of the dampers, i.e. the first value, the rotation of the fan is out of a range where the system can be considered to be in proper operation from an energy savings point of view. Thus, depending on the first value, the representation of the fan in the GUI can be turned red to indicate the improper operation, thus enabling a user or operator to make necessary actions to improve the system or system behaviour.

Examples on parameters for how representations of virtual components are to be viewed are stroke colour, stroke width, stroke style, fill colour, visibility, text content, font, alignment, opacity, position, size, form, angle, start of animation, stop of animation, colour gradients, duration, repetition, interval, etc. These parameters can be made easier to handle by assigning elements for building the graphical representations of the virtual components. These elements can be animation, sequence, gradients, skew, rotation, area, group, image, textbox, path, curve, pie, arc, rectangle, square, ellipse, circle, polygon, polyline, line, etc. By assigning values, either directly associated to values of binding points or via one or more functions, as discussed above, the graphical representation of the virtual components can be made to flexibly achieve an intuitive and clear view of the system and its components and functions.

Furthermore, static parameters can also be set globally, e.g. by omitting to assign any properties to some of the virtual components 110, and instead letting these virtual components inherit the properties, e.g. from other virtual components being on a higher hierarchical level or from the virtual system of the model 106 as a whole, i.e. being statically and globally set. These properties, no matter which of the above demonstrated ways they are assigned, can be assigned for different abstraction levels of the virtual component 110, and different abstraction levels within a virtual component can be assigned properties in different of the above demonstrated ways.

In dependence on assigned properties and collected values from the binding points 108, the representations of the virtual components 110 are displayed on a display 114 of the GUI. A representation of the entire system can be viewed, or an operator can select parts of the system, e.g. by a zoom function of the GUI. Thus, the GUI also provides an input interface 116 to enable an operator to control the GUI, and also to input values, commands, and confirmations to control operation. This is possible since the GUI is connected to and under control of the processor 104. This also provides for the processor 104 interact with an operator via the GUI. The input interface 116 can be any known input means known in the art of computing, such as a keypad, keyboard, joystick, mouse, touch screen, etc. As will be further described below, a number of editing functions are also enabled by the interaction between processor, GUI, and operator.

So far, it has been described how the processor 104 and its model 106 have collected values from the binding points. It has been described that properties for a virtual component can depend on a value of one or more binding points, and that properties of a plurality of virtual components can depend on the same one or more binding points. However, due to the ability for an operator to make inputs, values and also structures of the virtual system can be influenced by the operator, and this can be used to influence the actual system 100 in a similar way. This provides for an ability to control the operation of the actual system 100, either by operator input, signals automatically provided by the processor, or a combination of these. For example, the system 100 is a building control system, and a representation of a component is an animated handle. The operator virtually turns the handle a certain amount by using the GUI, say representing cranking up the desired temperature in a room by two degrees. The animated handle illustrates the turn on the display, and the processor determines a value assigned to be dependent on the virtual turn of the handle. The value is associated with one or more binding points, maybe via one or more functions, e.g. for providing the most economical and energy saving way of increasing the temperature in that room. These binding points are assigned these values, maybe as a function over time, and the actual system, which is connected to the binding points, will act accordingly to provide the desired temperature in that room. Other building related functionalities that can be controlled by the system in a similar way are heating, ventilation, air-conditioning, lighting, security functions, access control functions, surveillance, elevators, escalators, fire alarm systems, blinds, shutters, louvers, etc.

Here, we can see another advantage of the present invention: the virtual component can be “smarter” than the actual component. Thus, the actual system can be upgraded by the model of it instead of actually changing some of its components. This can provide for energy savings, increased security, improved features, etc. in an existing system 100, e.g. a building control system, a control system for a production line, or a control system for a vessel.

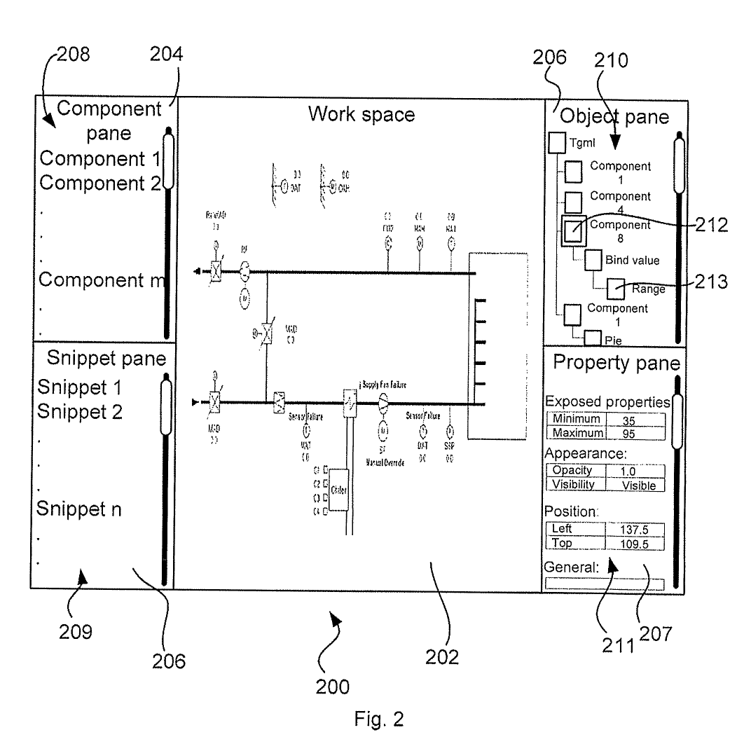

FIG. 2 is an exemplary screen view 200 of the display of the GUI when editing functions are provided. A work space 202 is provided for editing, wherein the work space 202 is adjacent to different panes 204207 for tools and functions.

In the present example, the work space 202 hold a part of a model of an automation control system, which for example is to be changed due to actual changes in the corresponding automation control system. For enabling editing, there can be provided a component pane 204 holding a number of different components 208 to be selectably added to the model of the system, e.g. by drag-and-drop to the work space 202. Here, it should be noted that created structures in the work space 202 can be grouped to complex components and then added to the component pane 204, e.g. by drag-and-drop, for being able to use the same structure of the complex component later in e.g. another part of the model of the system.

In a similar way, there can be a pane 205 for snippets 209. A snippet is a piece of program code, e.g. for programming properties of a component, that can be reused in other parts of the model. Therefore, these are saved in a snippet library from which at least an extract is viewed in the snippet pane 205. Also in a similar way as for the component pane 204, snippets 209 from the snippet pane 205 can be selectably added to components of the model, or to structured groups of components, here called objects, e.g. by drag-and-drop to the work space 202. Here, it should be noted that snippets that have been created or amended, which can be performed in a snippet editor, during the work in the work space 202 can be added to the snippet pane 205, e.g. by drag-and-drop, for being able to use these later in e.g. another part of the model of the system.

An object pane 206 hold information linked to the displayed model, and can be regarded as a text and block version of the model. The objects 210 are normally hierarchically structured, wherein the root level of an object tree can be considered to represent the data structure or software representing the model, and the branches and leaves of the object tree are representations of the model for enabling an operator to easily assign properties to any part of the model. In the present example, an object 212 is selected through the GUI. Properties of the selected object 212 is then displayed in a property pane 207, where a number of properties 211 are displayed, and also can be assigned new properties by operator input through the GUI. In the present example, the selected object 212 contains an object 213 for converting a bind value within a range to a range for a virtual component to which the bind value is associated. A maximum and a minimum value is exposed on a component level, i.e. for component 212, and can thus be assigned. Thus, the physical value provided to the binding point can be fitted into proper ranges to be used by the virtual components to correctly reflect desired information from the actual system. Further, properties for viewing, etc. is assigned for the selected object 212 in the property pane 207. In the property pane 207, properties 211 can selectably assigned as globally assigned, as locally assigned, or as not assigned, i.e. to be inherited, for any object at any level, which level is indicated in the object pane 206.

The invention has mainly been described above with reference to a few embodiments. However, as is readily appreciated by a person skilled in the art, other embodiments than the ones disclosed above are equally possible within the scope of the invention, as defined by the appended patent claims.

I claim:

1. An automation control management tool comprising
a processor,
a graphical user interface, and
a set of binding points to enable connection to an automation control system, wherein
said processor holds a model of said automation control system,
said model comprising a plurality of virtual components arranged in a hierarchical structure associated with functions of corresponding actual components of said automation control system, wherein
each virtual component is assigned a set of properties for viewing a representation of said virtual component by said graphical user interface, wherein
said each set of properties comprises
a first subset of properties being linked to said binding points such that actual values for corresponding actual components are provided to said virtual components, and
a second subset of properties being assigned parameters for how said representation of said virtual component is to be viewed with respect to said actual values, wherein
each property of said second subset of properties selectably comprises a locally or a globally assigned parameter.

2. The tool according to claim 1, wherein said locally assigned properties depend on a value of at least one binding point.

3. The tool according to claim 1, wherein said globally assigned properties depend on a value of at least one binding point.

4. The tool according to claim 1, wherein said globally assigned properties depend on a set of values of a set of binding points.

5. The tool according to claim 1, wherein two or more of said locally or globally assigned properties depend on one value of one of said binding points.

6. The tool according to claim 1, comprising an editing mode, wherein said graphical user interface provides a field for editing said parameters.

7. The tool according to claim 6, wherein a locally assigned parameter is editable by accessing said representation of said virtual component in said editing mode.

8. The tool according to claim 6, wherein a globally assigned parameter is editable by exposing said global parameter and performing at least one of the actions comprising:
amending the parameter; and
re-naming the parameter.

9. The tool according to claim 6, wherein said set of properties comprise a selectable assigned minimum value and a selectable assigned maximum value.

10. The tool according to claim 1, wherein a representation of a virtual component in said graphical user interface is arranged to receive a user settable value, wherein said value is linked to its associated binding point for controlling said corresponding actual component.

11. The tool according to claim 1, comprising a component editor, wherein a component of said virtual components is editable.

12. The tool according to claim 11, wherein said component editor enable grouping of a plurality of components as sub-components of a complex component, wherein said complex component is handled as any virtual component.

13. The tool according to claim 1, comprising a model editor, wherein said model is editable.

14. The tool according to claim 1, comprising a snippet library comprising snippets defining properties to enable assigning said properties to a virtual component.

15. The tool according to claim 14, further comprising a snippet editor, wherein an edited snippet is added to said snippet library.

16. An automation control system comprising a physical automation control system and a management tool comprising
a processor,
a graphical user interface, and
a set of binding points to enable connection to said physical automation control system, wherein
said processor holds a model of said physical automation control system,
said model comprising a plurality of virtual components arranged in a structure associated with functions corresponding actual components of said physical automation control system, wherein
each virtual component is assigned a set of properties for viewing a representation of said virtual component by said graphical user interface, wherein
said each set of properties comprises
a first subset of properties being linked to said binding points such that actual values for corresponding actual components are provided to said virtual components, and
a second subset of properties for how said representation of said virtual component is to be viewed in said graphical user interface with respect to said actual values, wherein
each property of said second subset of properties selectably comprises a locally or a globally assigned parameter.

17. The system according to claim 16, wherein said globally assigned properties depend on a value of at least one binding point.

18. The system according to claim 16, wherein said globally assigned properties depend on a set of values of a set of binding points.

19. The system according to claim 16, wherein a set of globally assigned properties depend on a value of one binding point.

20. The system according to claim 16, wherein two or more of said locally or globally assigned properties depend on one value of one of said binding points.

21. The system according to claim 16, wherein a representation of a virtual component in said graphical user interface is arranged to receive a user settable value, wherein said value is linked to its associated binding point for controlling said corresponding actual component.

22. A method for use in a device, comprising
associating virtual components of a model of an automation control system with actual components of the automation control system;
assigning a set of properties to said virtual components;
viewing a representation of said virtual components according to said set of properties, wherein
said each set of properties comprises
a first subset of properties being linked to said binding points such that actual values for corresponding actual components are provided to said virtual components, and
a second subset of properties comprising parameters for how said representation of said virtual component is to be viewed with respect to said actual values, wherein said method further comprises
assigning said parameters selectably locally or globally of each property of said second subset of properties.

23. The method according to claim 22, further comprising editing said parameters.

24. The method according to claim 22, further comprising
selecting a virtual component for editing;
accessing said representation of said selected virtual component; and
assigning said parameter locally.

25. The method according to claim 22, further comprising
exposing a globally assigned parameter; and
amending said exposed parameter.

26. The method according to claim 22, further comprising
assigning for a selected property a minimum value; and
assigning a maximum value for said selected property.

27. The method according to claim 22, further comprising
receiving a user selectable value associated with a representation of a virtual component; and
assigning said user selectable value to a binding point for controlling a corresponding actual component.

28. The method according to claim 22, further comprising
editing a virtual component, wherein said editing comprises grouping a plurality of components as sub-components of a complex component, and assigning said complex component as a virtual component.

29. The method according to claim 22, further comprising editing said model.

30. The method according to claim 22, further comprising
accessing a snippet from a snippet library, wherein said snippet defines properties of a virtual component;
editing said snippet; and
storing said edited snippet in said snippet library.

31. A computer program stored on a computer readable medium, said computer program comprising program code adapted to perform the method according to claim 22 when the program is run on a computer.

32. A data structure comprising
a link to a set of binding points enabling connection to an automation control system; and
a model of said automation control system, wherein said model comprises
a plurality of virtual components arranged in a structure associated with functions of said automation control system, wherein each virtual component is assigned a set of properties for viewing a representation of said virtual component, wherein each set of properties comprises a first sub-set of properties being linked to said binding points such that actual values for corresponding actual component are provided to said virtual component, and a second sub-set of properties for how said representation of said virtual component is to be viewed with respect to said actual values, wherein each property of said second sub-set of properties selectably comprises a locally or a globally assigned parameter.

33. The data structure according to claim 32, wherein said locally assigned properties depend on a value of at least one binding point.

34. The data structure according to claim 32, wherein said globally assigned properties depend on a value of at least one binding point.

35. The data structure according to claim 32, wherein said globally assigned properties depend on a set of values of a set of binding points.

36. The data structure according to claim 32, wherein two or more of said locally or globally assigned properties depend on one value of one of said binding points.

37. The data structure according to claim 32, wherein a globally assigned parameter is editable by exposing said global parameter and performing at least one of the actions comprising:
amending the parameter; and
re-naming the parameter.

38. The data structure according to claim 32, wherein said set of properties comprise a selectable assigned minimum value and a selectable assigned maximum value.

39. The data structure according to claim 32, wherein a virtual component of said virtual components is a group of a plurality of components as sub-components of a complex component, wherein said complex component is handled as any virtual component.

40. The data structure according to claim 32, further comprising a snippet library comprising snippets defining properties to enable assigning said properties to a virtual component.
